(19) United States
(12) Patent Application Publication
(10) Pub. No.: US 2009/0196452 A1
(43) Pub. Date: Aug. 6, 2009

(54) MICROPHONE ASSEMBLY CAPABLE OF AVOIDING DEFORMATION AND SHIFTING OF NON-WOVEN FABRIC

(75) Inventors: Nengbin Wan, Cupertino, CA (US); Bo Zhang, Nanjing (CN); Yi-Wen Chen, Taipei (TW); Ming Zhang, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/356,574

(22) Filed: Jan. 21, 2009

Related U.S. Application Data
(60) Provisional application No. 61/026,166, filed on Feb. 5, 2008.

(51) Int. Cl. H04R 11/04; B32B 37/12

(52) U.S. Cl. 381/365; 381/361; 156/272.2

(57) ABSTRACT

A microphone assembly includes a flexible holder, a microphone, and a piece of non-woven fabric. The flexible holder has a top opening. The microphone is fitted into the flexible holder. The piece of non-woven fabric is attached to the microphone and totally disposed in the top opening of the flexible holder.

### CROSS REFERENCE TO RELATED APPLICATIONS

This application claims the benefit of U.S. Provisional Application No. 61/026,166, filed Feb. 5, 2008.

### BACKGROUND OF THE INVENTION

1. Field of the Invention

The invention relates to a microphone assembly, and more particularly to a microphone assembly capable of avoiding deformation and shifting of a non-woven fabric.

2. Description of the Related Art

Referring to FIG. 1, an omni-directional microphone 70 has an acoustic hole 702 on the top to receive sound. A piece of non-woven fabric 80 is glued to the top of the omni-directional microphone 70, for preventing entry of water and dust into the microphone 70 through the acoustic hole 702.

FIG. 2 is a flow chart depicting the production of the microphone 70. In step S21, the microphone 70 is heated. In step S22, the non-woven fabric 80 is glued to the microphone 70 by epoxy resin, and then the epoxy resin is dried and hardened due to the heat from the microphone 70. In step S23, the microphone 70 is tested.

Note that the microphone 70 expands due to heating in step S21, and the non-woven fabric 80 is attached to the expanded microphone 70 in step S22. Thus, when the microphone 70 cools down and contracts to its original size, the non-woven fabric 80 on the microphone 70 deforms. The deformation of the non-woven fabric 80 should be avoided as it negatively affects the phase response obtained from the microphone 70.

Referring to FIGS. 3A and 3B, a flexible holder 90 has a top opening 901 and a bottom opening 902. The microphone 70 is squeezed into the flexible holder 90 through the bottom opening 902. The flexible holder 90, is generally made of rubber, and is used for protecting the microphone 70 from external vibrations.

When the microphone 70 is squeezed into the flexible holder 90, the non-woven fabric 20 sustains a directional pull P1 and a directional press P2 by the flexible holder 90 and may deform and shift, which significantly and negatively affects the phase response obtained from the microphone 70.

### BRIEF SUMMARY OF THE INVENTION

The invention provides a microphone assembly capable of avoiding deformation and shifting of the non-woven fabric. The microphone assembly in accordance with an exemplary embodiment of the invention includes a flexible holder, a microphone, and a piece of non-woven fabric. The flexible holder has a top opening. The microphone is fitted into the flexible holder. The piece of non-woven fabric is attached to the microphone and totally disposed in the top opening of the flexible holder.

In another exemplary embodiment, the microphone has a surface and an acoustic hole on the surface, and the piece of non-woven fabric covers the acoustic hole.

In yet another exemplary embodiment, the acoustic hole and the piece of non-woven fabric are round, and the acoustic hole exceeds the piece of non-woven fabric in diameter.

In another exemplary embodiment, the microphone assembly further includes an oriented polypropylene film by which the piece of non-woven fabric is attached to the microphone.

In yet another exemplary embodiment, the microphone is an omni-directional microphone.

The invention also provides an electronic device including the above microphone assembly. The electronic device in accordance with an exemplary embodiment of the invention includes a front cover, the above microphone, a circuit board, and a rear cover. The front cover has a storage space. The microphone assembly is disposed in the storage space. The microphone of the microphone assembly is mounted on the circuit board. The rear cover pushes the circuit board toward the front cover.

In another exemplary embodiment, the electronic device further includes another microphone mounted on the circuit board. The microphones constitute a microphone array.

In yet another exemplary embodiment, the electronic device is a notebook computer.

In another exemplary embodiment, the electronic device is a cellular phone.

In yet another exemplary embodiment, the electronic device is a personal digital assistant (PDA).

In another exemplary embodiment, the electronic device is a global positioning system (GPS) receiver.

In yet another exemplary embodiment, the electronic device is a liquid crystal display (LCD).

In another exemplary embodiment, the electronic device is a speakerphone.

The invention also provides a process for producing the above microphone assembly. The process in accordance with an exemplary embodiment of the invention includes the steps of: first, adhering a piece of non-woven fabric to a microphone by glue; second, baking the microphone to dry the glue; and third, testing the microphone.

In another exemplary embodiment, the glue is an oriented polypropylene (OPP) film.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective diagram of an omni-directional microphone and a non-woven fabric;

FIG. 2 is a flow chart depicting the production of the omni-directional microphone of FIG. 1;

FIG. 3A is an exploded diagram of the microphone of FIG. 1 and a flexible holder;

FIG. 3B depicts the assembly of the microphone and the flexible holder of FIG. 3A;

FIG. 4 is a perspective diagram of an omni-directional microphone and a non-woven fabric in accordance with an embodiment of the invention;

FIG. 5 is a flow chart depicting the production of the omni-directional microphone of FIG. 4;

FIG. 6A is an exploded diagram of the microphone of FIG. 4 and a flexible holder;

FIG. 6B depicts the assembly of the microphone and the flexible holder of FIG. 6A; and

FIG. 7 is a sectional view of an electronic device containing two omni-directional microphones of FIG. 4.

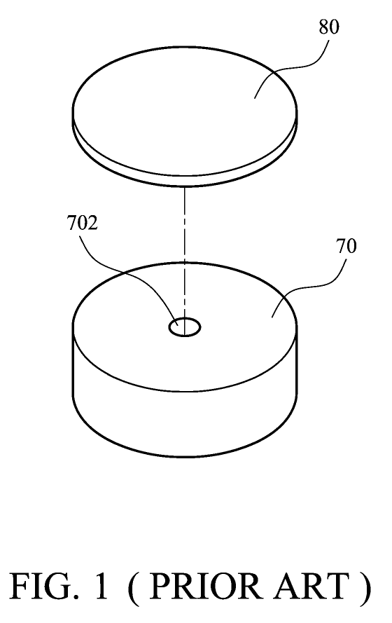

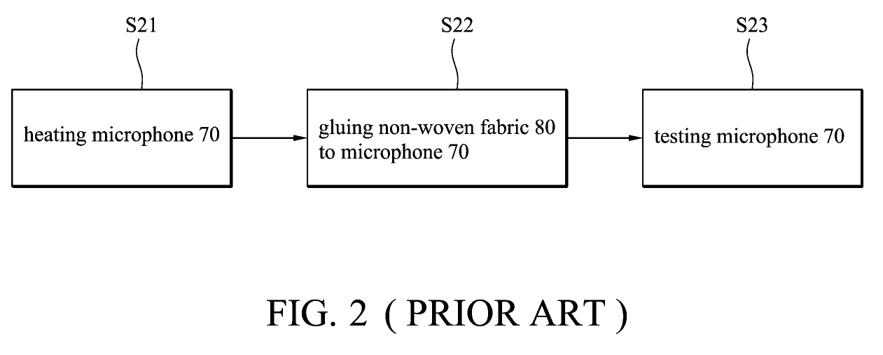

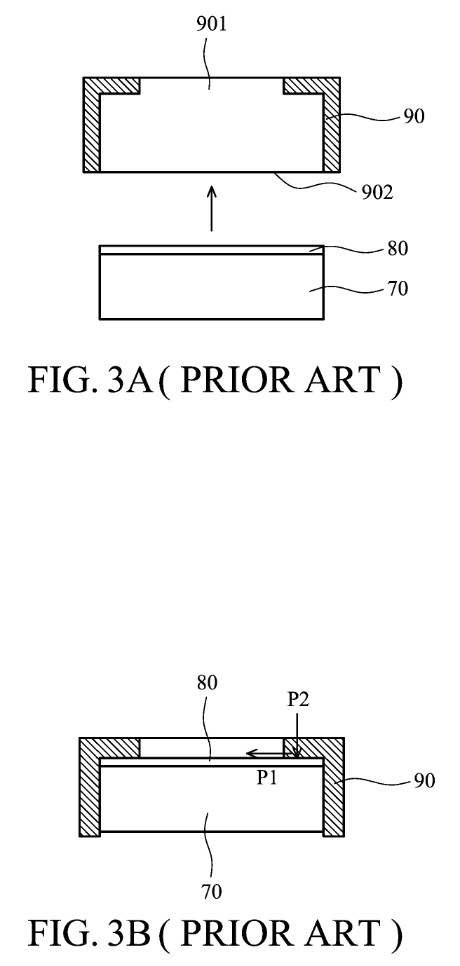

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

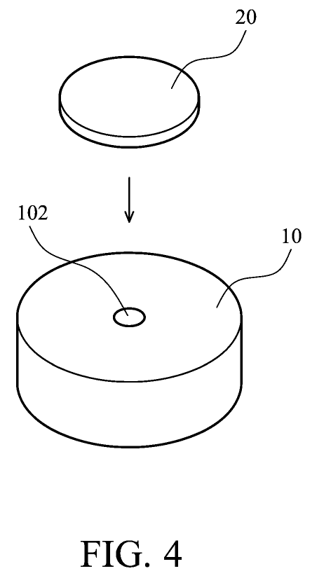

Referring to FIG. 4, an omni-directional microphone 10 has an acoustic hole 102 on the top to receive sound. A piece of non-woven fabric 20 is attached to the top of the omni-directional microphone 10 by glue, for covering the acoustic hole 102. Thus, the piece of non-woven fabric 20 is capable of preventing entry of water and dust into the microphone 10 through the acoustic hole 102. In this embodiment, the glue is an oriented polypropylene (OPP) film which has high elasticity and viscosity and is insusceptible to deformation.

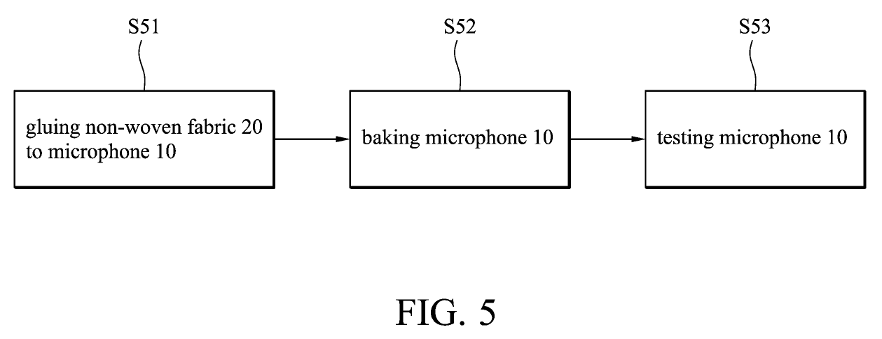

FIG. 5 is a flow chart depicting the production of the microphone 10. In step S51, the non-woven fabric 20 is glued to the microphone 10. In step S52, the microphone 10 is baked for drying the glue. In step S53, the microphone 10 is tested. Note that the gluing step (step S51) is carried out before the baking step (step S52), to avoid deformation of the non-woven fabric 20 when the microphone 10 cools down.

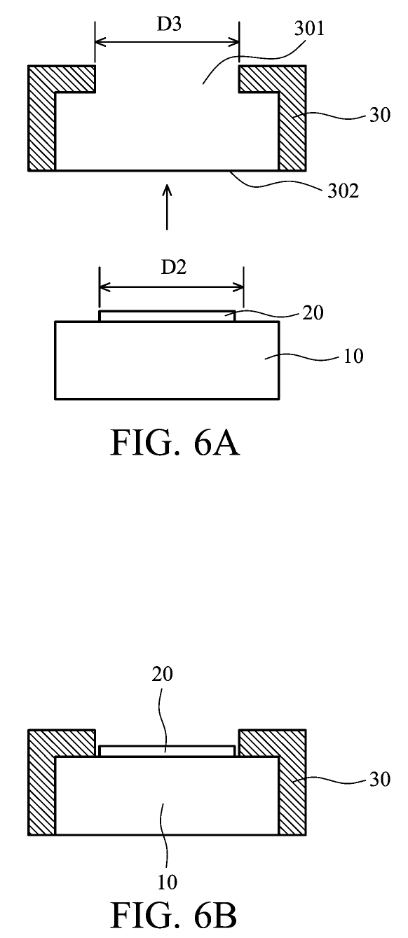

Referring to FIGS. 6A and 6B, a flexible holder 30 has a top opening 301 and a bottom opening 302. The top opening 301 has a diameter of D₃. The microphone 10 is squeezed into the flexible holder 30 through the bottom opening 302. The flexible holder 30 is made of rubber for protecting the microphone 10 from external vibrations.

The non-woven fabric 20 has a diameter of D₂. D₂ is less than D₃ so that the non-woven fabric 20 can be totally disposed in the top opening 301 when the microphone 10 is fitted into the flexible holder 30 as shown in FIG. 6B. This arrangement prevents the directional pull and/or press by the flexible holder 30 on the non-woven fabric 20, which causes deformation and/or shifting of the non-woven fabric 20 on the microphone 10 as in the conventional art.

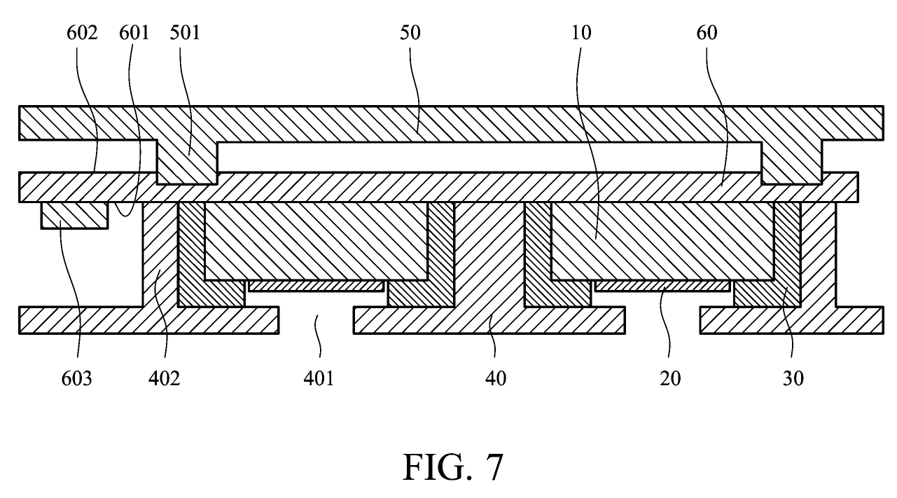

FIG. 7 is a sectional view of an electronic device containing two omni-directional microphones 10. The electronic device includes a front cover 40 and a rear cover 50. A plurality of sound openings 401 is provided in the front cover 40 allowing external sound to enter.

The front cover 40 has a plurality of wall portions 402 protruding inward to form a plurality of storage spaces. That is, the storage spaces are encircled by the wall portions 402. Also, the sound openings 401 of the front cover 40 are connected to the storage spaces.

A circuit board 60 has a first surface 601, a second surface 602 opposing the first surface 601, and an integrated circuit chip 603 mounted on the second surface 602. The two omni-directional microphones 10 are mounted on the first surface 601 of the circuit board 60 to constitute a microphone array. Furthermore, the two omni-directional microphones 10 are fitted into the two flexible holders 30 and then disposed in the storage spaces. Thus, the omni-directional microphones 10 are capable of receiving external sound via the sound opening 401 of the front cover 40.

A plurality of ribs 501 protrudes from the rear cover 50 and pushes the circuit board 60 toward the front cover 40.

The flexible holders 30 protect the internal omni-directional microphones 10 from vibrations and also prevent sound leakage of the internal omni-directional microphones 10. To begin, the flexible holders 30 are slightly larger than the storage spaces. However, the ribs 501 of the rear cover 50 push the circuit board 60 toward the front cover 40. Thus, the flexible holders 30 are squeezed and contracted until the circuit board 60 contacts the wall portions 402 of the front cover 40. As a result, the flexible holders 30 are tightly held between the omni-directional microphones 10 and the wall portions 402 to prevent sound leakage. Namely, the omni-directional microphones 10 in the storage spaces can only receive external sound via the sound openings 401.

The electronic device may be a notebook computer, a cellular phone, a personal digital assistant (PDA), a global positioning system (GPS) receiver, a liquid crystal display (LCD), a speakerphone, and others.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone assembly, comprising:
a flexible holder having a top opening;
a microphone fitted into the flexible holder; and
a piece of non-woven fabric attached to the microphone and totally disposed in the top opening of the flexible holder.

2. The microphone assembly as claimed in claim 1, wherein the microphone has a surface and an acoustic hole on the surface, and the piece of non-woven fabric covers the acoustic hole.

3. The microphone assembly as claimed in claim 1, wherein the acoustic hole and the piece of non-woven fabric are round, and the acoustic hole exceeds the piece of non-woven fabric in diameter.

4. The microphone assembly as claimed in claim 1, further comprising an oriented polypropylene film by which the piece of non-woven fabric is attached to the microphone.

5. The microphone assembly as claimed in claim 1, wherein the microphone is an omni-directional microphone.

6. An electronic device, comprising:
a front cover having a storage space;
the microphone assembly as claimed in claim 1, disposed in the storage space;
a circuit board on which the microphone of the microphone assembly is mounted; and
a rear cover pushing the circuit board toward the front cover.

7. The electronic device as claimed in claim 6, further comprising another microphone mounted on the circuit board, wherein the microphones constitute a microphone array.

8. The electronic device as claimed in claim 6, wherein the electronic device is a notebook computer, a cellular phone, a personal digital assistant, a global positioning system receiver, a liquid crystal display, or a speakerphone.

9. A process for producing a microphone assembly comprising:
adhering a piece of non-woven fabric to a microphone by glue;
baking the microphone to dry the glue; and
testing the microphone.

10. The process for producing the microphone assembly as claimed in claim 9, wherein the glue is an oriented polypropylene film.
